(19) United States
(12) Patent Application Publication
(10) Pub. No.: US 2024/0364221 A1
(43) Pub. Date: Oct. 31, 2024

(54) PERFORMANCE OF MULTIPHASE VOLTAGE REGULATOR

(71) Applicant: TEXAS INSTRUMENTS INCORPORATED, Dallas, TX (US)

(72) Inventors: Sreelakshmi Suresh, Bangalore (IN); Preetam Tadeparthy, Bangalore (IN); Vikas Lakhanpal, Bilaspur (IN); Vikram Gakhar, Bangalore (IN)

(21) Appl. No.: 18/224,818

(22) Filed: Jul. 21, 2023

(30) Foreign Application Priority Data
Apr. 26, 2023 (IN) 202341030038

(51) Int. Cl. H02M 3/158; H02M 1/00; H02M 3/157

(52) U.S. Cl. CPC H02M 3/1584; H02M 1/0009; H02M 1/0025; H02M 3/157

(57) ABSTRACT

At least one example describes mechanisms to improve performance of a multiphase voltage regulator. In at least one example, an integrated circuit is provided which includes control circuitry coupled to a first power stage and a second power stage. The first power stage and a second power stage are coupled to an output power supply rail, wherein the control circuitry generates a first pulse width modulated signal for the first power stage and a second pulse width modulated signal for the second power stage. In at least one example, the control circuitry aligns rise and fall times of the first pulse width modulated signal and the second pulse width modulated signal based on an undershoot condition being detected on the output power supply rail.

### CLAIM OF PRIORITY

This application claims priority to Indian Provisional Patent Application No. 202341030038, filed on Apr. 26, 2023, titled “NON-LINEAR TECHNIQUES TO ENHANCE MULTIPHASE BUCK REGULATOR PERFORMANCE DURING UNDERSHOOT AND POST-UNDERSHOOT RESPONSE,” and which is incorporated by reference in entirety.

### BACKGROUND

Voltage regulators are used to provide a regulated voltage supply to one or more loads. One type of voltage regulator is a multi-phase buck regulator.

### BRIEF DESCRIPTION OF DRAWINGS

The examples will be understood more fully from the detailed description given below and from the accompanying drawings, which, however, should not be taken to limit the disclosure to the specific examples, but are for explanation and understanding only.

FIG. 1 illustrates a system with a multiphase voltage regulator, in accordance with at least one example.

FIG. 2 illustrates a portion of a system with a multiphase voltage regulator, in accordance with at least one example.

FIG. 3 illustrates part of a controller of a multiphase voltage regulator, in accordance with at least one example.

FIG. 4 illustrates a timing diagram showing an operation of the controller during normal operation, in accordance with at least one example.

FIG. 5 illustrates a timing diagram showing an operation of a multiphase voltage regulator.

FIG. 6 illustrates a timing diagram showing operation of a multiphase voltage regulator where a controller aligns an individual group of pulse width modulated signals in parallel to reduce undershoot, in accordance with at least one example.

FIG. 7 illustrates a flowchart showing an operation of a controller to align an individual group of pulse width modulated signals to reduce undershoot, in accordance with at least one example.

FIG. 8 illustrates a timing diagram showing an operation of a multiphase voltage regulator where a controller extends pulse width of pulse width modulated signals to reduce undershoot, in accordance with at least one example.

FIG. 9 illustrates a timing diagram showing an increase in current sourced into individual inductors based on widths of pulse width modulated signals, in accordance with at least one example.

FIG. 10 illustrates a timing diagram showing shortening of pulse widths during normal operation for pulse width modulated signals that were extended to reduce undershoot, in accordance with at least one example.

FIG. 11 illustrates a flowchart showing an operation of a controller to extend pulse widths of pulse width modulated signals to reduce undershoot and then to shorten pulse widths of pulse with modulated signals, in accordance with at least one example.

FIG. 12 illustrates a timing diagram showing an operation of a multiphase voltage regulator where number of pulses for pulse width modulated signals is increased to reduce undershoot, in accordance with at least one example.

FIG. 13 illustrates a flowchart showing an operation of dynamically adjusting the number of pulses by control of controller comparator operation, in accordance with at least one example.

FIG. 14 illustrates a flowchart showing an operation of dynamically adjusting the number of pulses, in accordance with at least one example.

### SUMMARY

In at least one example, one or more circuitries are provided to improve performance of a multiphase voltage regulator by reducing undershoot. In at least one example, an integrated circuit is provided which comprises a first power stage coupled to an input power supply rail, wherein the first power stage is configured to drive a first current to an output power supply rail. In at least one example, the integrated circuit further comprises a second power stage coupled to the input power supply rail, wherein the first power stage is configured to drive a second current to the output power supply rail. In at least one example, the integrated circuit further comprises a control circuitry coupled to the first power stage and the second power stage. In at least one example, the control circuitry is configured to generate a first pulse width modulated signal for the first power stage. In at least one example, the control circuitry is configured to generate a second pulse width modulated signal for the second power stage. In at least one example, the control circuitry is configured to align rise and fall times of the first pulse width modulated signal and the second pulse width modulated signal based on an undershoot condition being detected on the output power supply rail.

In at least one example, a system is provided which comprises a first inductor. In at least one example, the system further comprises a second inductor. In at least one example, the system further comprises a capacitor coupled to the first inductor and the second inductor. In at least one example, the system further comprises a processor circuitry coupled to the first inductor, the second inductor, and the capacitor. In at least one example, the system further comprises an integrated circuit coupled to the first inductor and the second inductor. In at least one example, the integrated circuit comprises a first power stage coupled to an input power supply rail, wherein the first power stage is configured to drive a first current to an output power supply rail. In at least one example, the integrated circuit comprises a second power stage coupled to the input power supply rail, wherein the first power stage is configured to drive a second current to the output power supply rail. In at least one example, the integrated circuit comprises a control circuitry coupled to the first power stage and the second power stage. In at least one example, the control circuitry is configured to generate a first pulse width modulated signal for the first power stage. In at least one example, the control circuitry is configured to generate a second pulse width modulated signal for the second power stage. In at least one example, the control circuitry is configured to align rise and fall times of the first pulse width modulated signal and the second pulse width modulated signal based on an undershoot condition being detected on the output power supply rail.

In at least one example, one or more non-transitory machine-readable storage media are provided having machine-readable instructions stored thereon that, when executed, cause one or more machines to perform a method to improve performance of a multiphase voltage regulator. In at least one example, the method comprises driving a first current to an output power supply rail. In at least one example, the method further comprises driving a second current to the output power supply rail. In at least one example, the method further comprises generating a first pulse width modulated signal to produce the first current. In at least one example, the method further comprises generating a second pulse width modulated signal to produce the second current. In at least one example, the method further comprises detecting an undershoot condition on the output power supply rail. In at least one example, the method further comprises aligning rise and fall times of the first pulse width modulated signal and the second pulse width modulated signal based on the undershoot condition being detected on the output power supply rail.

In at least one example, an integrated circuit is provided which comprises a first power stage coupled to an input power supply rail, wherein the first power stage is configured to drive a first current to an output power supply rail. In at least one example, the integrated circuit comprises a second power stage coupled to the input power supply rail, wherein the first power stage is configured to drive a second current to the output power supply rail. In at least one example, the integrated circuit comprises a control circuitry coupled to the first power stage and the second power stage. In at least one example, the control circuitry is configured to generate a first pulse width modulated signal for the first power stage. In at least one example, the control circuitry is configured to generate a second pulse width modulated signal for the second power stage. In at least one example, the control circuitry is configured to extend a first pulse width of the first pulse width modulated signal based on an undershoot condition being detected on the output power supply rail. In at least one example, the control circuitry is configured to extend a second pulse width of the second pulse width modulated signal based on the undershoot condition being detected on the output power supply rail.

In at least one example, a system is provided which comprises a first inductor; a second inductor; a capacitor coupled to the first inductor and the second inductor; a processor circuitry coupled to the first inductor, the second inductor, and the capacitor; and an integrated circuit coupled to the first inductor and the second inductor. In at least one example, the integrated circuit comprises a first power stage coupled to an input power supply rail, wherein the first power stage is configured to drive a first current to an output power supply rail. In at least one example, integrated circuit comprises a second power stage coupled to the input power supply rail, wherein the first power stage is configured to drive a second current to the output power supply rail. In at least one example, the integrated circuit comprises a control circuitry coupled to the first power stage and the second power stage. In at least one example, the control circuitry is configured to generate a first pulse width modulated signal for the first power stage. In at least one example, the control circuitry is configured to generate a second pulse width modulated signal for the second power stage. In at least one example, the control circuitry is configured to extend a first pulse width of the first pulse width modulated signal based on an undershoot condition being detected on the output power supply rail. In at least one example, the control circuitry is configured to extend a second pulse width of the second pulse width modulated signal based on the undershoot condition being detected on the output power supply rail.

In at least one example, one or more non-transitory machine-readable storage media are provided having machine-readable instructions stored thereon that when executed, cause one or more machines to perform a method. In at least one example, the method comprises driving a first current to an output power supply rail. In at least one example, the method comprises driving a second current to the output power supply rail. In at least one example, the method comprises generating a first pulse width modulated signal to produce the first current. In at least one example, the method comprises generating a second pulse width modulated signal to produce the second current. In at least one example, the method comprises detecting an undershoot condition on the output power supply rail. In at least one example, the method comprises extending a first pulse width of the first pulse width modulated signal based on the undershoot condition being detected on the output power supply rail. In at least one example, the method comprises extending a second pulse width of the second pulse width modulated signal based on the undershoot condition being detected on the output power supply rail.

In at least one example, an integrated circuit is provided which comprises a first power stage coupled to an input power supply rail, wherein the first power stage is configured to drive a first current to an output power supply rail. In at least one example, the integrated circuit comprises a second power stage coupled to the input power supply rail, wherein the first power stage is configured to drive a second current to the output power supply rail. In at least one example, the integrated circuit comprises a control circuitry coupled to the first power stage and the second power stage. In at least one example, the control circuitry is configured to generate a first pulse width modulated signal for the first power stage. In at least one example, the control circuitry is configured to generate a second pulse width modulated signal for the second power stage. In at least one example, the control circuitry is configured to increase a number of pulses of the first pulse width modulated signal based on an undershoot condition being detected on the output power supply rail. In at least one example, the control circuitry is configured to increase a number of pulses of the second pulse width modulated signal based on the undershoot condition being detected on the output power supply rail.

In at least one example, the control circuitry includes a comparator which compares an average current error or average voltage error with a reference. In at least one example, the control circuitry is configured to adjust a duration for the comparator to be active based on detection of an undershoot condition on the output power supply rail and based on lapse of the undershoot condition.

In at least one example, a non-transitory machine-readable storage media is provided having machine-readable instructions stored thereon that when executed, causes one or more machines to perform a method to improve performance of a voltage regulator. In at least one example, the method comprises driving a first current to an output power supply rail. In at least one example, the method comprises driving a second current to the output power supply rail. In at least one example, the method comprises generating a first pulse width modulated signal to produce the first current. In at least one example, the method comprises generating a second pulse width modulated signal to produce the second current. In at least one example, the method comprises detecting an undershoot condition on the output power supply rail. In at least one example, the method comprises comparing, by a comparator, an average current error or average voltage error with a reference. In at least one example, the method comprises adjusting a duration for the comparator to be active based on detection of the undershoot condition on the output power supply rail and based on lapse of the undershoot condition.

### DETAILED DESCRIPTION

Disclosed herein are one or more mechanisms to improve performance of a multiphase voltage regulator. In at least one example, one or more mechanisms include one or more circuitries that may be custom designed. In at least one example, one or more mechanisms include one or more circuitries that may be synthesized logic. In at least one example, one or more mechanisms include one or more circuitries that are software controllable. In at least one example, multiphase voltage regulator comprises a buck converter. In at least one example, one or more circuitries align two or more pulse width modulated signals for two or more phases in an undershoot condition. In at least one example, one or more circuitries increase pulse widths of pulse width modulated signals in an undershoot condition. In at least one example, one or more circuitries dynamically increase a number of pulse width modulated signals in an undershoot condition. In at least one example, one or more circuitries dynamically decrease pulse widths of pulse width modulated signals after an undershoot condition lapses. In at least one example, one or more circuitries decrease blanking time for a comparator of a controller in an undershoot condition. In at least one example, one or more circuitries increase blanking time for a comparator of a controller after an undershoot condition lapses.

While at least one example here is described with reference to a multiphase buck voltage regulator, other types of multiphase voltage regulators may be used. In at least one example, multiphase voltage regulator is a boost converter. In at least one example, multiphase voltage regulator is a buck-boost converter.

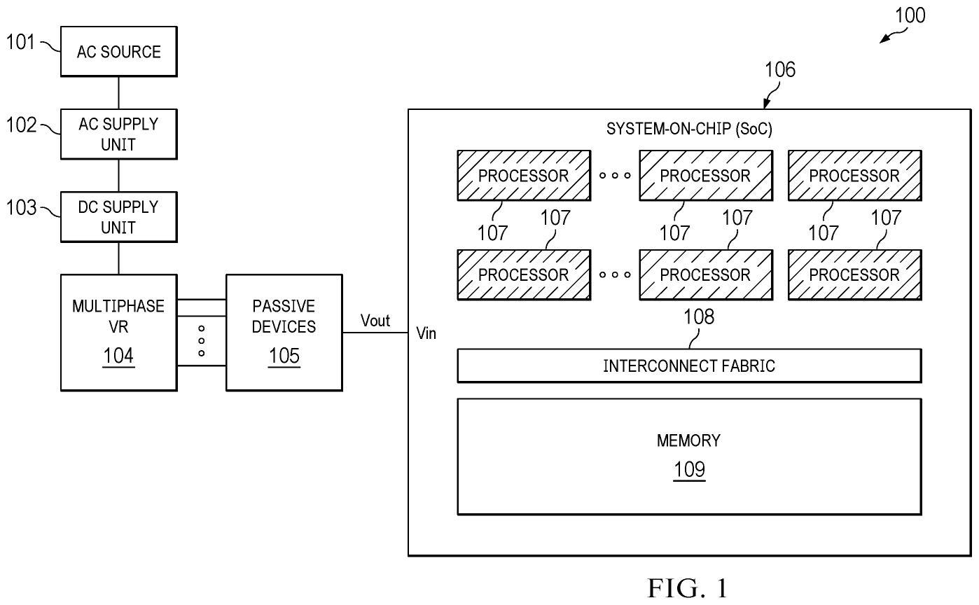

FIG. 1 illustrates system 100 with a multiphase voltage regulator, according to at least one example. In at least one example, system 100 is a computer system (e.g., a personal computer, server, tablet, smart phone, laptop, desktop, etc.). In at least one example, system 100 comprises alternating current (AC) source 101, AC supply unit 102, direct current (DC) supply unit 103, multiphase voltage regulator 104, passive devices 105, and system-on-chip (SoC) 106. In at least one example, AC source 101 is an AC wall socket that provides AC supply to one or more components. In at least one example, AC source 101 provides a 220 Volts (V) voltage at 50 Hz of frequency. In at least one example, AC source 101 provides AC input supply to AC supply unit 102. In at least one example, AC supply unit 102 comprises a transformer that down-converts an input AC supply (e.g., voltage and/or current) to an output AC supply. In at least one example, DC supply unit 103 receives output AC supply from AC supply unit 102 and generates an input supply (e.g., Vin) for multiphase voltage regulator 104. In at least one example, Vin may be less than 220 V. In at least one example, multiphase voltage regulator 104 receives input supply Vin from DC supply unit 103 and generates a multiphase output which is received by passive devices 105. In at least one example, passive devices 105 include inductors and a load capacitor. In at least one example, an individual inductor is coupled to an output of multiphase voltage regulator 104. In at least one example, inductors of passive device 105 are coupled to a load capacitor, and charge developed on the load capacitor provides output supply Vout to system-on-chip 106. Here, node name and signal name on that node are interchangeably used. For example, Vout may refer to Vout node (e.g., Vout supply rail) or signal Vout depending on context of the sentence.

In at least one example, system-on-chip 106 comprises one or more components. In at least one example, one or more components of system-on-chip 106 includes one or more processors 107. In at least one example, one or more processors 107 are individual processor dies that are communicatively coupled through interconnects (e.g., by a substrate or interposer). In at least one example, one or more processors 107 are processor cores. In at least one example, individual processors of one or more processors 107 include processor cores. In at least one example, one or more processor cores are homogenous cores with same size and capability. In at least one example, one or more processor cores are heterogeneous cores with different sizes and different capabilities. In at least one example, system-on-chip 106 includes interconnect fabric 108. In at least one example, interconnect fabric 108 connects various components of system-on-chip 106 with one another. In at least one example, system-on-chip 106 includes memory 109. In at least one example, memory 109 comprises one or more dynamic random-access memory (DRAM), magnetic random-access memory (MRAM), ferroelectric random-access memory (FeRAM), resistive random-access memory (ReRAM), etc.

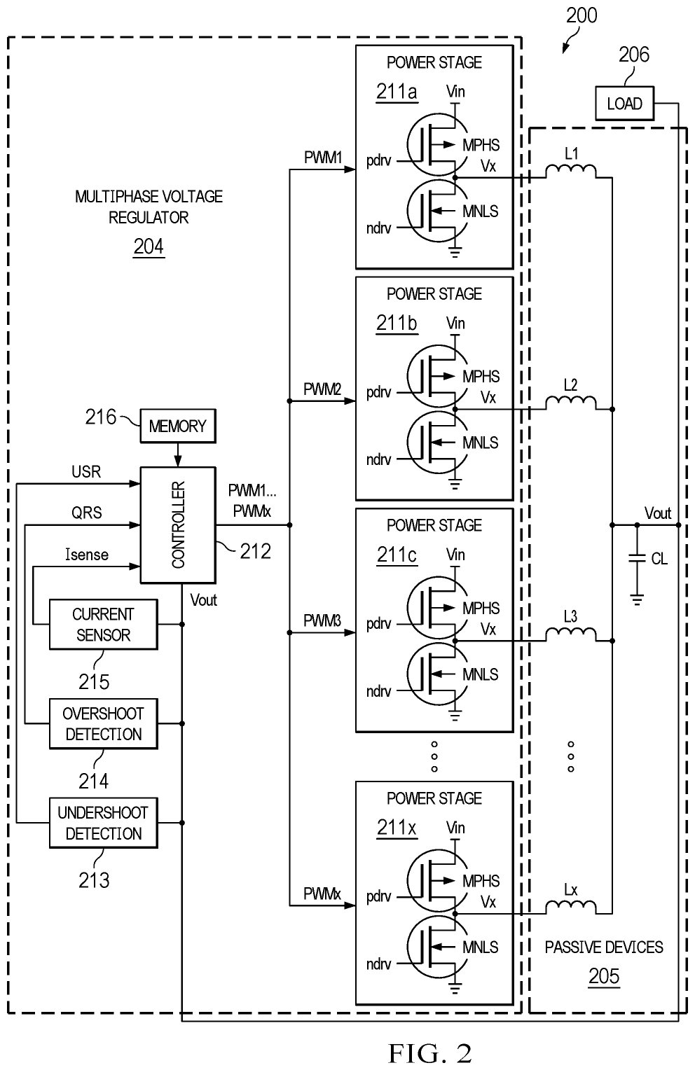

FIG. 2 illustrates portion 200 of system 100 with multiphase voltage regulator 204, according to at least one example. In at least one example, portion 200 comprises multiphase voltage regulator 204, passive device 205, and load 206. In at least one example, multiphase voltage regulator 204 comprises power stages (or drivers) 211a, 211b, 221c, . . . 211x (where ‘x’ is a number greater than 3), controller 212, undershoot detection circuitry 213, overshoot detection circuitry 214, current sensor 215, and memory 216.

In at least one example, power stage 211a comprises a p-channel driver or high-side switch MPHS and an n-channel driver or low-side switch MNLS. In at least one example, high-side switch MPHS is driven by or controlled by signal pdrv, which is derived from a pulse width modulated signal (e.g., PWM1) generated by controller 212. In at least one example, high-side switch MPHS receives input supply Vin from a DC supply unit (e.g., DC supply unit 103). In at least one example, low-side switch MNLS is driven by or controlled by signal ndrv, which is derived from a pulse width modulated signal (e.g., PWM1) generated by controller 212. In at least one example, low-side switch MNLS is coupled to a low reference (e.g., ground). In at least one example, a common node Vx, which couples high-side switch MPHS and low-side switch MNLS, is coupled to passive devices 205.

In at least one example, an individual power stage is controlled by a pulse width modulated signal. In at least one example, pulse width modulated signal PWM1 from controller 212 controls or drives power stage 211a. In at least one example, pulse width modulated signal PWM2 from controller 212 controls or drives power stage 211b. In at least one example, pulse width modulated signal PWM3 from controller 212 controls or drives power stage 211c, and so on. In at least one example, pulse width modulated signal PWMx generated by controller 212 controls or drives power stage 211x, and so on.

In at least one example, controller 212 receives output voltage Vout or a version of Vout (e.g., a divided down version of Vout) as feedback and generates pulse width modulated signals PWM1 through PWMx. In at least one example, controller 212 varies the pulse widths of the pulse width modulated signals according to a difference between output voltage Vout and a reference level, where controller 212 determines output voltage Vout with reference to a reference level. In at least one example, controller 212 also receives telemetry information from sensors (e.g., current sensor, voltage sensor, etc.) to adjust the pulse width of the pulse width modulated signals.

In at least one example, undershoot detection circuitry 213 (or sensor) monitors Vout relative to a reference and generates a USR pulse indicating duration of an undershoot condition. An undershoot condition occurs when voltage Vout falls below a threshold level (e.g., a steady state level of voltage Vout, 20% below steady state level of voltage Vout, or any other suitable percentage threshold level relative to steady state level of voltage Vout). In at least one example, the threshold level to determine an undershoot condition is a programmable level (e.g., programmable by software, hardware, or a combination of them). In at least one example, the pulse width of the USR captures the duration of undershoot as it occurs. In at least one example, once the USR pulse ends, the undershoot condition lapses. In at least one example, controller 212 receives the USR pulse and changes or modifies characteristics (e.g., pulse width and/or timing) of the pulse width modulated signals according to the USR pulse.

In at least one example, overshoot detection circuitry 214 (or sensor) monitors Vout relative to a reference and generates a ORS pulse indicating duration of an overshoot condition. An overshoot condition occurs when volage Vout rises above a threshold level (e.g., a steady state level of voltage Vout, 20% above steady state level of voltage Vout, or any other suitable percentage threshold level relative to steady state level of voltage Vout). In at least one example, the threshold level to determine an overshoot condition is a programmable level (e.g., programmable by software, hardware, or a combination of them). In at least one example, the pulse width of ORS pulse captures the duration of overshoot as it occurs. In at least one example, once the pulse of ORS ends, the overshoot condition lapses. In at least one example, controller 212 receives the ORS pulse and changes or modifies characteristics (e.g., pulse width and/or timing) of the pulse width modulated signals according to the ORS pulse.

In at least one example, current sensor 215 monitors current through node Vout relative to a reference signal Isense indicative of sensed current. In at least one example, Isense captures duration of overcurrent or undercurrent through node Vout as it occurs. In at least one example, controller 212 receives Isense and changes or modifies characteristics (e.g., pulse width and/or timing) of pulse width modulated signals according to Isense.

In at least one example, memory 216 stores values of one or more parameters that are used by controller 212 to modify characteristics of pulse width modulated signals PWM1 through PWMx during various conditions of Vout (e.g., overshoot, undershoot, overcurrent, and/or undercurrent). In at least one example, one or more parameters stored in memory 216 are programmable parameters that can be programmed by hardware, software, or firmware. In at least one example, one or more parameters stored in memory 216 include the number of pulse width modulated signals in a group. In at least one example, one or more parameters stored in memory 216 include blanking time for a comparator of controller 212, where blanking time is a time in which comparator output is discarded or forced a value. In at least one example, one or more parameters stored in memory 216 include a number of blanking times for different conditions of output voltage Vout (e.g., undershoot condition, overshoot condition, after undershoot condition lapses, etc.).

In at least one example, output Vx of individual power stages is coupled to a terminal of an individual inductor of passive devices 205. In at least one example, passive devices 205 include inductors L1, L2, and L3 through Lx, and load capacitor CL, where x is a number greater than 3. In at least one example, inductors L1, L2, and L3 through Lx are one or more of air core inductors, toroidal inductors, laminated core inductors, powdered iron core inductors, axial inductors, shielded surface mount inductors, coupled inductors, multilayer chip inductors, shielded variable inductor, molded inductors, or ceramic core inductors. In at least one example, a substrate within it includes inductors L1, L2, and L3 through Lx. In at least one example, an interposer includes within it inductors L1, L2, and L3 through Lx. In at least one example, capacitor CL is one a ceramic capacitor, film capacitor, power film capacitor, electrolytic capacitor, transistor configured as a capacitor, ferroelectric capacitor, metal-insulator-metal (MIM) capacitor, an on-die capacitor, or an off-die capacitor.

In at least one example, output Vx of power stage 211a is coupled to a first terminal of inductor L1, while a second terminal of inductor L1 is coupled to output supply node Vout. In at least one example, output Vx of power stage 211b is coupled to a first terminal of inductor L2, while a second terminal of inductor L2 is coupled to output supply node Vout. In at least one example, output Vx of power stage 211b is coupled to a first terminal of inductor L2, while a second terminal of inductor L2 is coupled to output supply node Vout. In at least one example, output Vx of power stage 211c is coupled to a first terminal of inductor L3, while a second terminal of inductor L3 is coupled to output supply node Vout, and so on. In at least one example, output Vx of power stage 211x is coupled to a first terminal of inductor Lx, while a second terminal of inductor Lx is coupled to output supply node Vout.

In at least one example, controller 212 monitors undershoot condition on Vout by monitoring the USR signal from undershoot detection circuitry 213 to align a group of PWM pulses. In at least one example, a group of PWM pulses includes two or more pulses (e.g., PWM1 and PWM2 in a group). In at least one example, during a pulse of the USR signal, which indicates an undershoot condition, controller 212 issues or generates parallel pulses of pulse width modulated signals to cause power stages to collectively inject more current into load capacitor CL. In at least one example, a group of pulse width modulated signals are aligned (e.g., rise and fall times of PWM pulses are aligned) during an undershoot condition on Vout. In at least one example, individual groups of pulse width modulated signals are separated in time and are issued in a round robin manner. In at least one example, after controller 212 determines that undershoot condition has lapsed, controller 212 proceeds to normal operation of generating pulse width modulated signals where controller 212 generates individual pulses in a round robin manner. In at least one example, controller 212 determines the number of pulses per group based on a programmable number storage in memory 216.

In at least one example, controller 212 extends the pulse width of pulse width modulated signals in response to detection of an undershoot condition on Vout. In at least one example, controller 212 extends the pulse width by a programmable amount. In at least one embodiment, memory 216 stores a value indicative of the programmable amount. In at least one example, power stages 211a through 211x provide more current to load capacitor CL from extension of pulse widths of pulse width modulated signals. In at least one example, controller 212 stops extension of pulse widths of pulse width modulated signals after the undershoot condition lapses. In at least one example, controller 212 reduces current to load capacitor CL, through power stages 211a through 211x that are turned on by discontinuing extension of pulse widths. In at least one example, during steady state condition of Vout, controller 212 shrinks the pulse width of the pulse width modulated signals that were extended during undershoot condition. In at least one example, controller 212 shrinks the pulse width of the pulse width modulated signals over successive cycles of the pulse width modulated signals so that the amount of extension of pulse width is zeroed out over successive cycles.

In at least one example, controller 212 increases the number of pulses generated during an undershoot condition. In at least one example, controller 212 increases the number of pulses by reducing blanking time of comparator of controller 212. In at least one example, as more pulse width modulated signals are generated in an undershoot condition, controller 212 provides more current to load capacitor CL as controller 212 frequently turns on power stages 211a through 211x. In at least one example, controller 212 reduces the number of pulses by increasing the blanking time of the comparator of controller 212 after the undershoot condition lapses. In at least one example, as blanking time increases, controller 212 reduces current to capacitor CL from power stages 211a through 211x. In at least one example, controller 212 reverts to normal blanking time when Vout is in steady state.

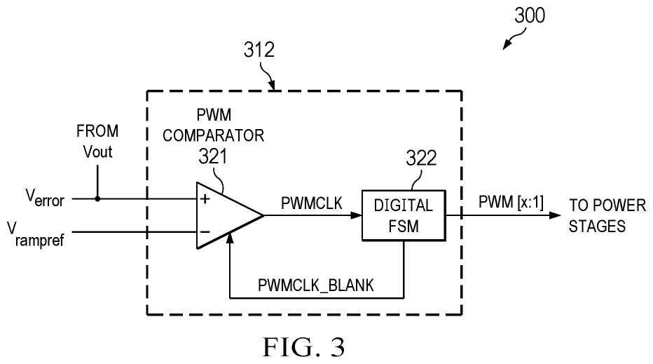

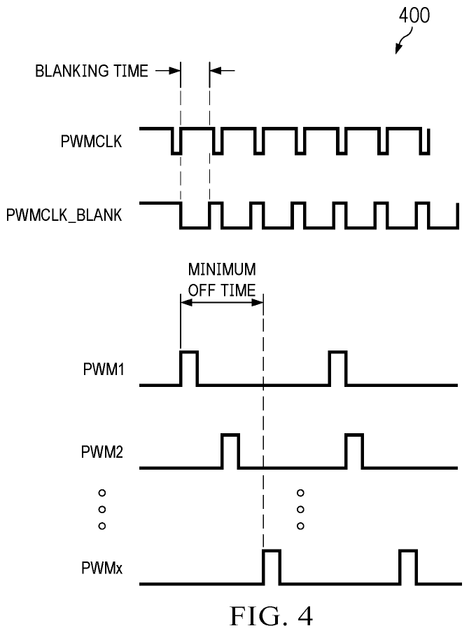

FIG. 3 illustrates schematic 300 which is part of controller 312 of a multiphase voltage regulator, according to at least one example. FIG. 4 illustrates timing diagram 400 showing an operation of the controller during normal operation, according to at least one example. FIG. 3 is described with reference to FIG. 4. In at least one example, schematic 300 comprises inputs Verror and Vrampref, outputs PWM1 through PWMx (herein PWM[x:1]), comparator 321, and digital finite state machine (FSM) 322. In at least one example, comparator 321 compares Verror (which is either Vout or derived from Vout) and a reference Vrampref, and generates output PWMCLK.

In at least one example, assertion of PWMCLK_BLANK to comparator 321 disables comparator 321 or forces a fixed value on output PWMCLK. Here, PWMCLK indicates to control loop (which includes digital FSM 322, power stages, passive devices, Vout, and comparator 321) that energy is desired at the Vout node or the supply rail. In at least one example, comparator 321 triggers PWMCLK to generate PWM pulses (e.g., PWM[x:1]) by digital FSM 322. In at least one example, digital FSM 322 generates PWM pulses for each phase (e.g., power stage) in a round robin manner. In at least one example, frequency of PWMCLK is limited or controlled by BLANKING TIME. In at least one example, BLANKING TIME of PWMCLK_BLANK defines a time window from the point of PWMCLK triggering, in which comparator 321 output is pulled low. In at least one example, BLANKING TIME ensures that noise in comparator 321 may not cause extra PWM pulses from any noisy condition.

In at least one example, the frequency of PWM pulse for each phase (e.g., power stage) is parameter MINIMUM OFF TIME. In at least one example, parameter MINIMUM OFF TIME refers to a time window from the falling edge of a PWM pulse, where a new PWMCLK to a phase (e.g., power stage) will not generate a PWM pulse until expiration of the time window.

In at least one example, digital FSM 322 asserts PWMCLK_BLANK after a PWM pulse is generated to filter any noise on Vout caused by current injection into capacitor CL. In at least one example, duration of PWMCLK_BLANK is long enough to avoid generation of PWMCLK based on noisy Verror. In at least one example, when PWMCLK_BLANK is small or zero, then comparator 321 may toggle PWMCLK based on noise on Verror. In at least one example, digital FSM 322 issues PWM pulse due to noise on Verror and this noise may in turn cause an overshoot on Vout.

In at least one example, in an undershoot condition, when controller 312 desires a larger amount of energy to mitigate undershoot on Vout, comparator 321 generates more PWMCLK pulses. In at least one example, control loop stability boundaries and parameters BLANKING TIME AND MINIMUM OFF TIME limit an amount of energy from the power stages. In at least one example, a memory (e.g., memory 216) stores a value for PWMCLK_BLANK.

In at least one example, digital FSM 322 dynamically controls an amount of energy to Vout by modifying characteristics of PWM pulses. In at least one example, digital FSM 322 modifies characteristics of PWM pulses by changing PWMCLK_BLANK time, aligning PWM pulses in a group, returning PWM pulses in round robin fashion, extending pulse width of PWM, shrinking pulse widths, and/or increasing or decreasing the number of pulses from comparator 321 for a phase (e.g., power stage) in an undershoot condition, after undershoot condition, and/or in steady state of output voltage Vout.

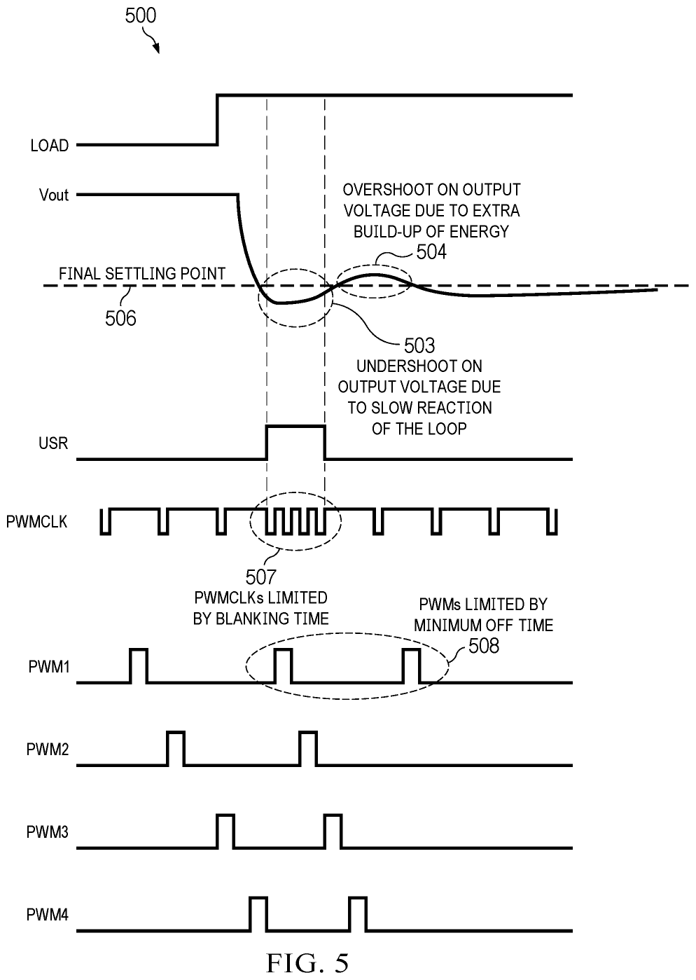

FIG. 5 illustrates timing diagram 500 showing an operation of a multiphase voltage regulator. In at least one example, when load 206 (e.g., system-on-chip 106) suddenly draws power as indicated by a step function for waveform load, voltage on supply rail Vout suddenly drops. This drop is referred to as a voltage droop. In at least one example, voltage droop comprises an undershoot region 503. In at least one example, a USR pulse captures undershoot region 503. In at least one example, undershoot condition is followed by an overshoot condition 504 or ring back. In at least one example, depending on control loop conditions, there may be several undershoot and overshoot conditions before Vout reaches steady state operating condition 506. In at least one example, PWMCLK pulses increase in a region defined by the USR pulse. In at least one example, blanking time 507 (e.g., PWMCLK_BLANK) limits the number of PWMCLK pulses. In at least one example, minimum off time 508 limits the number of PWM pulses. In at least one example, controller 212 or controller 312 generates pulses of pulse width modulated signals (e.g., PWM1 through PWM4) in a round robin fashion and drives respective power stages or phases in a round robin fashion.

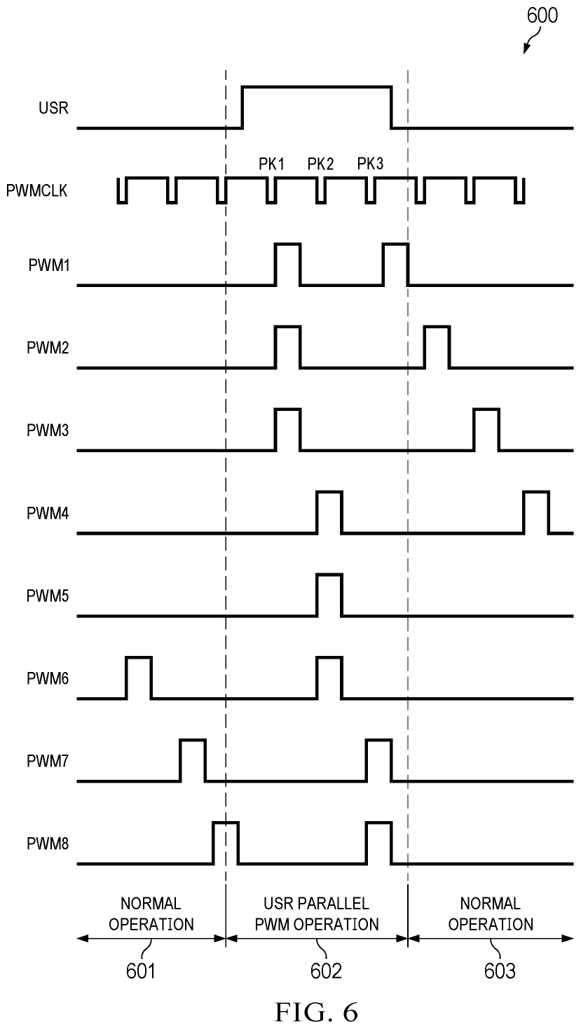

FIG. 6 illustrates timing diagram 600 showing operation of multiphase voltage regulator where a controller aligns an individual group of pulse width modulated signals in parallel to reduce undershoot, in accordance with at least one example. In at least one example, operation of multiphase voltage regulator has three regions: normal operation region 601, undershoot region 602, and normal operation region 603. In at least one example, operation of multiphase voltage regulator 204 may start an undershoot condition (e.g., undershoot region 602) followed by overshoot condition (not shown) and then normal operation (e.g., normal operation region 603).

In at least one example, in steady state operation or in normal operations regions 601 or 603, controller 212 or controller 312 fires or issues 1 PWM pulse per 1 PWMCLK (PK) for a power stage which drives charge on output node Vout. In at least one example, in undershoot operation region 602, controller 212 fires or issues parallel PWM pulses per 1 PK. In at least one example, in undershoot operation region 602, controller 212 or controller 312 maps 1 PK to N PWM pulses, where N is a positive integer. In at least one example, controller 212 or controller 312 builds up N-fold energy at output Vout with one PWMCLK.

Timing diagram 600 shows eight phases with eight pulse width modulated signals that drive eight power stages which are coupled to eight respective inductors and then to output Vout. In at least one example, during undershoot condition indicated by the USR pulse, controller 212 aligns pulses of pulse width modulated signals as a group or set. In this example, there are three pulse width modulated signals in a group. In at least one example, controller 212 may group any number of pulse width modulated signals in a group. In at least one example, after undershoot detection circuitry 213 identifies an undershoot condition, comparator 321 fires first PWMCLK (PK1) and digital FSM 322 aligns rise and fall times of PWM pulses in a group. In at least one example, controller 212 triggers PWM pulses in each group in a round robin manner within a USR pulse. In this example, controller 212 aligns PWM1, PWM2, and PWM3 pulses in a first group, aligns PWM4, PWM5, and PWM6 in a second group, and aligns PWM7, PWM8, and PWM1 in a third group. In at least one example, controller 212 separates in time and triggers the first group, the second group, and the third group in a round robin manner.

In this example, digital FSM 322 issues or fires PWM pulses (PWM1, PWM2, and PWM3) for power stages or phases 1, 2, and 3 (e.g., power stages 211a, 211b, and 211c, respectively) from PK1. In this example, digital FSM 322 issues or fires PWM pulses (PWM4, PWM5, and PWM6) for power stages or phases 4, 5, and 6 (e.g., power stages 211d, 211e, and 211f, (not shown) respectively) from PK2. In this example, digital FSM 322 issue or fires PWM pulses (PWM7, PWM8, and PWM9) for power stages or phases 7, 8, and 9 (e.g., power stages 211g, 211h, and 211i (not shown), respectively) from PK3. In at least one example, controller 212 or controller 312 builds up a higher amount of energy on load capacitor CL by issuing PWM pulses in parallel for power stages in a short duration of the USR pulse compared to parallel PWM pulses that are not issued in parallel during the USR pulse. In at least one example, controller 212 or controller 312 reduces or cancels current share issues between phases by issuing or firing of PWM pulses in a round robin manner, which activates power stages or phases in a round robin manner.

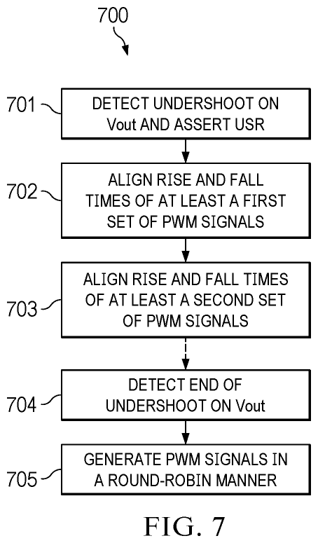

FIG. 7 illustrates flowchart 700 showing an operation of a controller to align an individual group of pulse width modulated signals to reduce undershoot, in accordance with at least one example. Hardware (e.g., digital FSM 322), software, firmware, or a combination of them may perform operation blocks of flowchart 700, in accordance with at least one example. Flowchart 700 represents operations described with reference to FIG. 6, in accordance with at least one example.

At operation block 701, undershoot detection circuitry 213 detects undershoot on output node Vout. In at least one example, undershoot detection circuitry 213 generates the USR pulse that indicates an undershoot condition on Vout. In at least one example, controller 212 receives the USR pulse and modifies rise and fall times of two or more PWM signals.

At operation block 702, controller 212 or controller 312 maps one PWMCLK assertion (e.g., output of comparator 321) with N PWM pulses. In at least one example, controller 212 or controller 312 maps a first PWMCLK in undershoot condition with a first set of PWM signals. In at least one example, any number of PWM signals can be part of first set of PWM signals. In at least one example, controller 212 or controller 312 maps a second PWMCLK in an undershoot condition with a second set of PWM signals, and so on. As such, in at least one example, controller 212 or controller 312 builds up multi-fold energy at Vout for each PWMCLK assertion. In at least one example, any number of PWM signals can be part of a second set of PWM signals. In at least one example, within the USR pulse or undershoot condition, controller 212 or controller 312 may generate any number of PWMCLK pulses, and so controller 212 or controller 312 may generate any number of parallel PWM pulses within the USR pulse.

In at least one example, mapping one PWMCLK to N PWM pulses is equivalent to aligning rise and fall times of N PWM pulses when a PWMCLK is asserted. In at least one example, controller 212 or controller 312 aligns rise and fall times of at least a first set of PWM signals when comparator 321 asserts a first PWMCLK within the USR pulse. At operation block 703, controller 212 or controller 312 aligns rise and fall times of at least a second set of PWM signals when the comparator asserts a second PWMCLK within the USR pulse, and so on. In at least one example, controller 212 or controller 312 generates the first set of PWM signals and the second set of PWM signals in a round robin manner. While flowchart 700 illustrates controller 212 or controller 312 aligning rise and fall times of two sets of PWM signals, controller 212 or controller 312 may align any number of sets of PWM signals within an undershoot operation region.

In at least one example, in operation block 704, undershoot detection circuitry 213 detects end or lapse of undershoot condition. In at least one example, undershoot detection circuitry 213 indicates end or lapse of undershoot condition by an end of the USR pulse. In at least one example, after the undershoot condition lapses, controller 212 or controller 312 generates PWM signals in a round robin manner in normal operation as indicated by operation block 705. In normal operation or steady state operation, controller 212 or controller 312 maps one PWMCLK to one PWM pulse that turns on one power stage, where controller 212 or controller 312 generates each PWM pulse for each PWMCLK in a round robin manner.

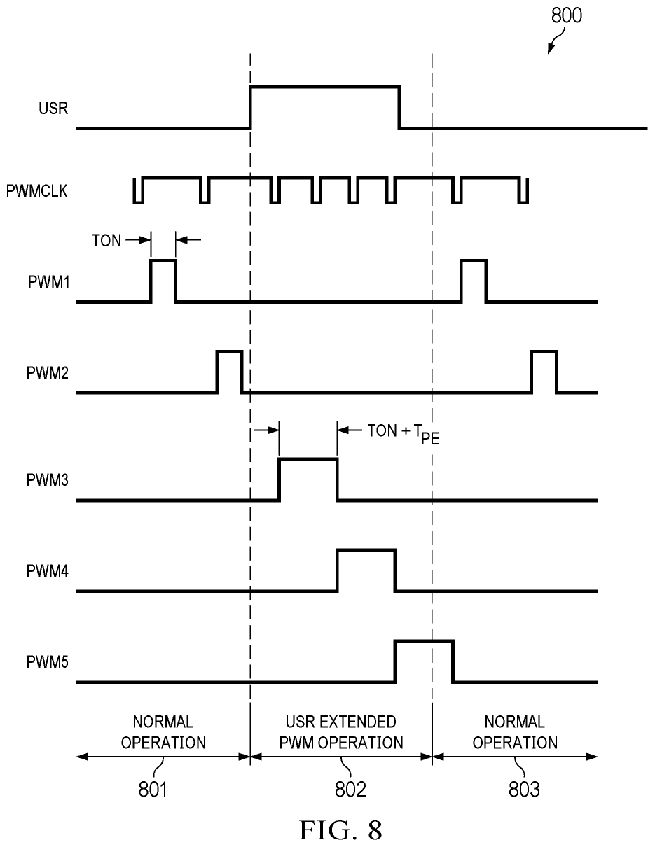

FIG. 8 illustrates timing diagram 800 showing an operation of the multiphase voltage regulator where a controller extends the pulse width of the pulse width modulated signals to reduce undershoot, in accordance with at least one example. In at least one example, operation of multiphase voltage regulator has three regions: normal operation region 801, undershoot operation region 802, and normal operation region 803. In at least one example, operation of multiphase voltage regulator may start with an undershoot condition (e.g., undershoot operation region 802) followed by an overshoot condition (not shown) and then normal operation (e.g., normal operation region 803). In at least one example, in steady state operation (e.g., normal operation region 801 or normal operation region 803), PWM pulses of multiphase voltage regulator have a constant on time defined as (Vout/Vin)*Tsw, where Tsw refers to the time period of the switching frequency. In at least one example, during an undershoot condition (e.g., undershoot operation region 803), controller 212 or controller 312 extends the PWM on time by ‘Tpe’ time (e.g., nanoseconds). In at least one example, controller 212 or controller 312 extends the PWM pulses in a round robin manner. In this example, controller 212 or controller 312 extends PWM3, PWM4, and PWM5 pulses in a USR pulse duration. In this example, controller 212 or controller 312 issues PWM1 and PWM2 pulses with normal pulse widths outside of the USR pulse duration. In at least one example, extension of PWM on time assists in building larger amount of energy on Vout with a single PWM pulse, hence resulting in a faster ramp-up of energy at Vout.

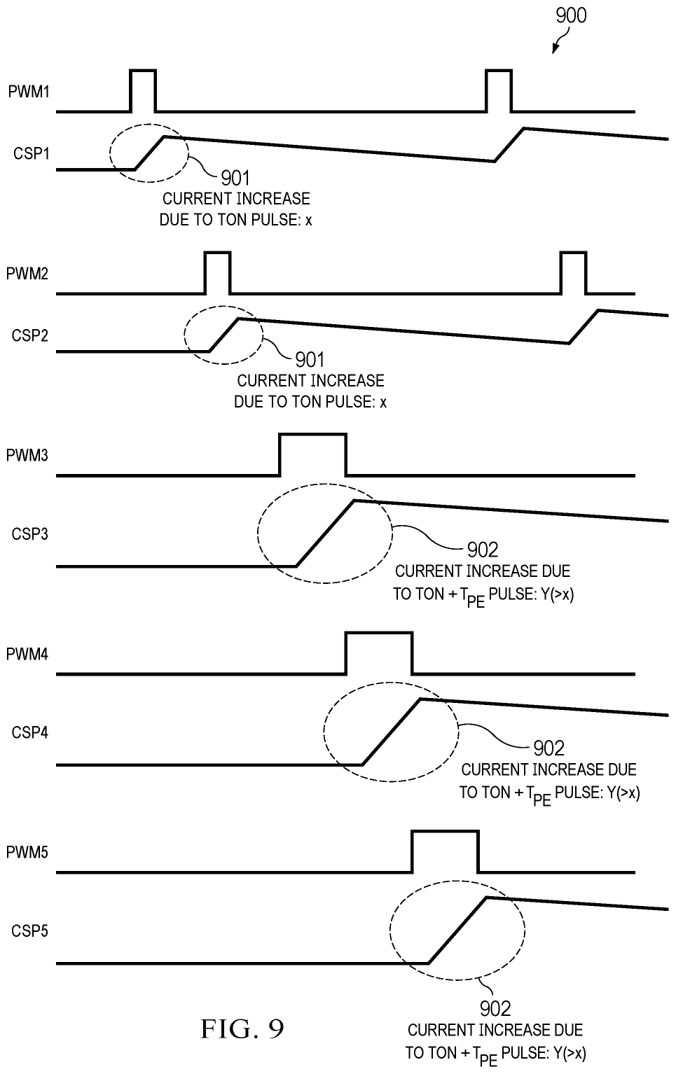

FIG. 9 illustrates timing diagram 900 showing an increase in current sourced into individual inductors based on widths of pulse width modulated signals, in accordance with at least one example. Timing diagram 900 corresponds to timing diagram 800. Timing diagram 900 shows charge current CSP for each pulse width modulated pulse. In this example, controller 212 generates PWM1 pulse and PWM2 pulse outside of the USR pulse, resulting in current increase due to Ton pulses 901 (e.g., CSP1 and CSP2). In this example, controller 212 generates PWM3 pulse, PWM4 pulse, PWM5 outside of the USR pulse, resulting in current increase due to Ton pulses 902 (e.g., CSP3, CSP4, and CSP5).

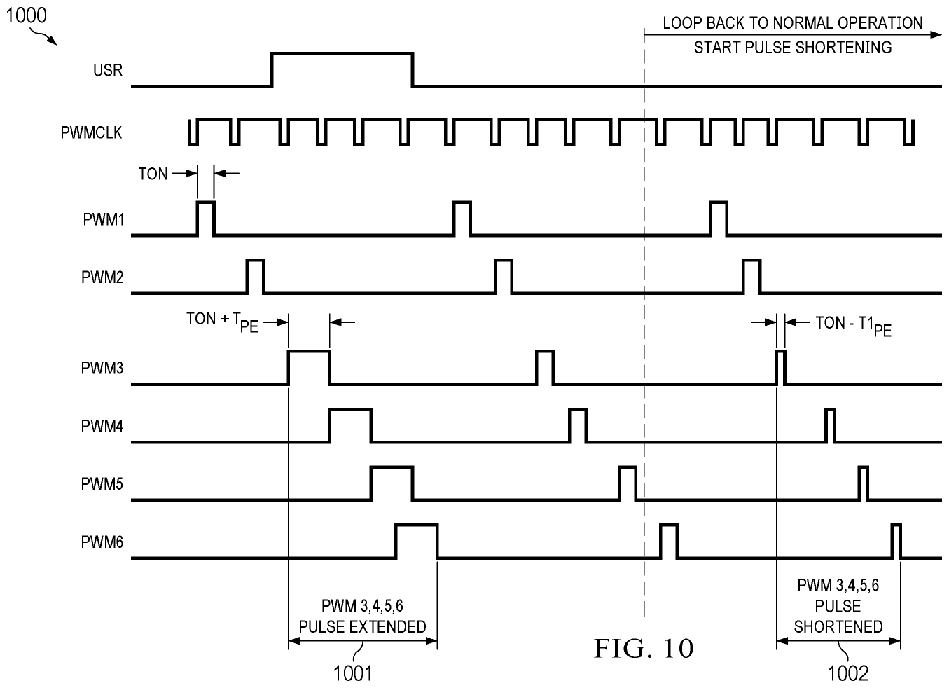

FIG. 10 illustrates timing diagram 1000 showing shortening of pulse widths during normal operation for pulse width modulated signals that were extended to reduce undershoot, in accordance with at least one example. Timing diagram 1000 illustrates timing diagram 800 and subsequent readjustment of pulse widths of PWM pulses that were extended. In at least one example, after controller 212 extends pulses of PWM pulses generated during the USR pulse, extra voltage is built on Vout, and this extra voltage corresponds to Tpe. In at least one example, extra voltage built on Vout results in a difference in currents between phases (e.g., power stage 211a generates a different current from PWM1 pulse compared to current from power stage 211c that receives PWM3 pulse). In at least one example, phases or power stages that receive extended PWM pulses source more current than phases or power stages that did not receive extended PWM pulses. As such, in at least one example, inductors of different phases receive different currents.

In at least one example, controller 212 mitigates imbalance of current in inductors caused by differing pulse durations of PWM pulses by shortening pulses in a subsequent cycle of PWMCLK. In at least one example, controller 212 shortens pulses of PWM pulses, which were previously extended, over a number of PWM cycles after voltage on the Vout node is in steady state. For example, if controller 212 extends PWM2 pulse by 40 ns in an undershoot condition, controller 212 then shortens PWM2 pulse by 10 ns over 4 PWM cycles (e.g., four PWMCLKs) after the voltage regulator exits a transient condition (e.g., overshoot and undershoot conditions). In at least one example, controller 212 shortens pulse widths of PWM pulses over a number of PWM cycles to ensure that current in the power phase reduces back to a correct value. In this example, controller 212 extends PWM pulses 3, 4, 5, and 6 (as indicated by 1001), and then reduces PWM pulses 3, 4, 5, and 6 in subsequent cycles (as indicated by 1002).

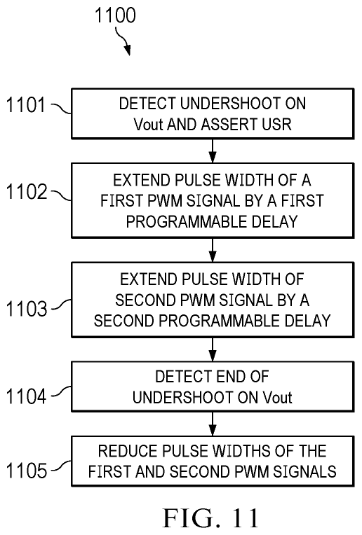

FIG. 11 illustrates flowchart 1100 showing an operation of a controller to extend pulse widths of pulse width modulated signals to reduce undershoot and then to shorten pulse widths of pulse width modulated signals, in accordance with at least one example. In at least one example, hardware (e.g., digital FSM 322), software, firmware, or a combination of them can perform operation blocks of flowchart 1100. Flowchart 1100 represents operations described with reference to FIGS. 9-10, in accordance with at least one example.

In at least one example, at operation block 1101, undershoot detection circuitry 213 detects undershoot on output node Vout. In at least one example, undershoot detection circuitry 213 generates the USR pulse that indicates an undershoot condition on Vout. In at least one example, controller 212 receives the USR pulse and extends the pulse width of the PWM signals that controller 212 generates in the USR pulse.

In at least one example, at operation block 1102, controller 212 extends the pulse width of a first PWM signal (e.g., PWM3 in FIG. 8) by a first programmable delay (e.g., Tpe). In at least one example, controller 212 reads first programmable delay from memory 216 and extends the pulse width of the PWM signal which is generated during the USR pulse. In at least one example, at operation block 1103, controller 212 extends the pulse width of a second PWM signal (e.g., PWM4 in FIG. 8) by a second programmable delay (e.g., Tpe). In at least one example, controller 212 reads second programmable delay from memory 216 and extends the pulse width of the PWM signal which is generated during the USR pulse. In at least one example, a first programmable delay is the same as a second programmable delay. In at least one example, there is one programmable delay parameter which controller 212 applies to PWM pulses that controller 212 generates in the USR pulse.

In at least one example, at operation block 1104, controller 212 detects an end or a lapse of an undershoot condition on Vout. In at least one example, the end or the lapse of the undershoot condition is indicated by the end of the USR pulse. In at least one example, controller 212 detects a steady state condition (e.g., when there is no overshoot or undershoot). In at least one example, the first PWM signal and the second PWM signal with extended pulses are generated in a round robin manner.

In at least one example, at operation 1105, controller 212 reduces pulse widths of first and second PWM pulses to ensure that current in phase reduces back to a correct value in over a number of PWM cycles. In at least one example, controller 212 shortens pulses of PWM pulses, which were previously extended, over a number of PWM cycles after voltage on Vout node is in steady state. While flowchart 1100 illustrates extending pulse widths of two PWM signals, pulse widths of any number of PWM signals may be extended within an undershoot operation region. In at least one example, after an undershoot condition is over, controller 212 shortens pulse widths of PWM signals that controller 212 previously extended in the undershoot condition.

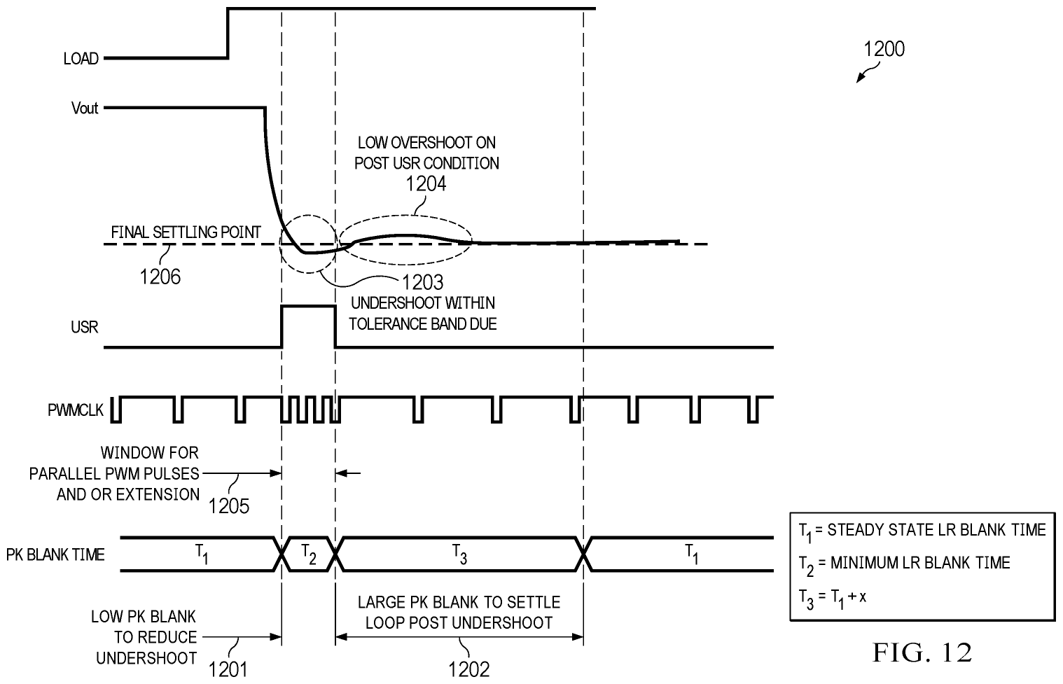

FIG. 12 illustrates timing diagram 1200 showing an operation of a multiphase voltage regulator where a number of pulses for pulse width modulated signals is increased to reduce undershoot, in accordance with at least one example. In at least one example, controller 212 increases a number of PWM pulses during the USR pulse. In at least one example, controller 212 increases the number of PWM pulses by reducing PWMCLK_BLANK time. As discussed herein, BLANKING TIME of PWMCLK_BLANK refers to a time where the output of comparator 321 is not based on a comparison of its inputs, but the BLANKING TIME of PWMCLK_BLANK is a known value, in accordance with at least one example. In at least one example, BLANKING TIME of PWMCLK_BLANK prevents noise on Vout from passing through comparator 321. In at least one example, BLANKING TIME of PWMCLK_BLANK ensures that noise in comparator 321 may not cause extra PWM pulses from any noisy condition.

In at least one example, controller 212 lowers BLANKING TIME of PWMCLK_BLANK for duration TI as indicated by 1201 during the USR pulse duration. In at least one example, after the USR pulse duration ends, controller 212 increases BLANKING TIME of PWMCLK_BLANK for duration T2 to settle control loop of voltage regulator post undershoot condition as indicated by 1202. Here, 1203 indicates undershoot on Vout within a tolerance band (e.g., a reference level). Here, 1204 indicates low overshoot on Vout post USR condition. Here, 1205 indicates a time window where controller 212 issues parallel PWM pulses, extended PWM pulses, or a combination thereof. Here, 1206 indicates steady state or a final settling point of voltage on Vout.

In at least one example, controller 212 employs a dynamic PWMCLK blanking scheme that increases PWMCLK blanking time, higher than the steady state value for a defined window after the undershoot condition is used to bring the loop back to steady operation faster. In at least one example, increasing PWMCLK blanking time (e.g., larger BLANKING TIME of PWMCLK_BLANK) decreases amount of energy given after undershoot condition, helping to settle the control loop faster and avoiding ring-back conditions on Vout.

In at least one example, when undershoot detection circuitry 213 (e.g., comparator of undershoot detection circuitry 213) decides that the undershoot condition is not present, controller 212 sets BLANKING TIME of PWMCLK_BLANK to a value NORMAL BLANKING TIME+X. In at least one example, ‘X’ is a time value stored in memory 216. In at least one example, ‘X’ is programmable by hardware, software, or a combination of them. In at least one example, controller 212 maintains extended BLANKING TIME of PWMCLK_BLANK (e.g., NORMAL BLANKING TIME+X) for ‘M’ PWMCLK pulses, where ‘M’ is a positive integer. In at least one example, ‘M’ number of PWMCLK pulses represents a time window where the control loop over-reacts due to extra energy build-up on Vout in an undershoot condition (e.g., USR pulse) from a smaller BLANKING TIME of PWMCLK_BLANK. A control loop may over-react by causing controller 212 to generate more PWM signals or pulses in a given time window compared to a control loop in steady state. In at least one example, software or hardware program values of ‘M’ and ‘N’ according to properties of load application, internal system settings, and/or output network parameters to get desired settling response of Vout, where ‘N’ is number of PWM pulses that are mapped to one PWMCLK cycle. In at least one example, memory 216 stores values of ‘M’ and ‘N’.

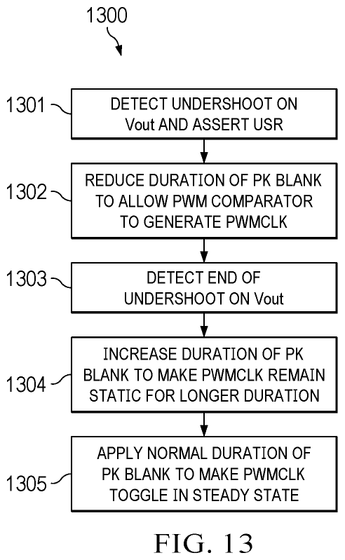

FIG. 13 illustrates flowchart 1300 showing an operation of dynamically adjusting the number of pulses with the controller comparator operation, in accordance with at least one example. In at least one example, hardware (e.g., digital FSM 322), software, firmware, or a combination of them can perform operation blocks of flowchart 1300. Flowchart 1300 represents operations described with reference to FIG. 12, in accordance with at least one example.

In at least one example, at operation block 1301, undershoot detection circuitry 213 detects undershoot on output node Vout. In at least one example, undershoot detection circuitry 213 generates a USR pulse that indicates an undershoot condition on Vout. In at least one example, at operation block 1302, controller 212 dynamically reduces BLANKING TIME of PWMCLK_BLANK to allow comparator 321 to generate more PWMCLK from inputs of comparator 321. In at least one example, as controller 212 or controller 312 generates more PWMCLK, more PWM pulses are generated. In at least one example, at operation block 1303, controller 212 or controller 312 detects the end of the USR pulse (e.g., end of undershoot condition). In at least one example, at operation block 1304, controller 212 or controller 312 dynamically increases the duration of BLANKING TIME of PWMCLK_BLANK after the undershoot condition lapses. In at least one example, increasing BLANKING TIME of PWMCLK_BLANK results in less noise from comparator 321 to generate PWMCLK. In at least one example, controller 212 or controller 312 maintains extended BLANKING TIME of PWMCLK_BLANK (e.g., NORMAL BLANKING TIME+X) for ‘M’ PWMCLK pulses, where ‘M’ is a positive integer. In at least one example, as discussed herein, ‘M’ number of PWMCLK pulses represents a time window where control loop over-reacts due to extra energy build-up on Vout in an undershoot condition (e.g., USR pulse) from smaller BLANKING TIME of PWMCLK_BLANK. A control loop may over-react by causing controller 212 to generate more PWM signals or pulses in a time window compared to a control loop in steady state. In at least one example, at operation block 1305, controller 212 applies a normal duration of BLANKING TIME of PWMCLK_BLANK (e.g., NORMAL BLANKING TIME) to make PWMCLK toggle in steady state.

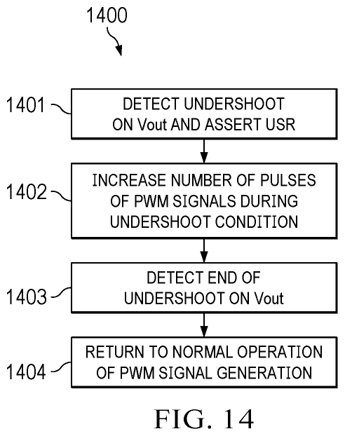

FIG. 14 illustrates flowchart 1400 showing an operation of dynamically adjusting the number of pulses, in accordance with at least one example. In at least one example, hardware (e.g., digital FSM 322), software, firmware, or a combination of them can perform operation blocks of flowchart 1400. Flowchart 1400 represents operations described with reference to FIG. 12, in accordance with at least one example.

In at least one example, at operation block 1401, undershoot detection circuitry 213 detects undershoot on output node Vout. In at least one example, undershoot detection circuitry 213 generates the USR pulse that indicates an undershoot condition on Vout. In at least one example, at operation block 1402, controller 212 or controller 312 increases number of PWM pulses, that are provided to power stages, during the USR pulse (e.g., undershoot condition). In at least one example, controller 212 or controller 312 increases a number of PWM pulses by dynamically reducing BLANKING TIME of PWMCLK_BLANK (e.g., smaller PWMCLK_BLANK) during an undershoot condition. In at least one example, at operation block 1403, controller 212 or controller 312 detects an end of the USR pulse (e.g., end of undershoot condition). In at least one example, based on the end of the undershoot condition, controller 212 or controller 312 returns to normal generation of PWM pulses (e.g., during steady state condition). In at least one example, at operation block 1404, controller 212 or controller 312 applies a normal duration of BLANKING TIME of PWMCLK_BLANK (e.g., NORMAL BLANKING TIME) to make PWMCLK toggle in steady state to generate a normal number of PWM pulses. In at least one example, between the end of the undershoot condition and the steady state condition, controller 212 or controller 312 controls or restricts the number of PWM pulses generated to allow the control loop to settle towards steady state.

In at least one example, one or more machine-readable storage media (e.g., memory) are provided which stores one or more machine-executable instructions. In at least one example, when one or more machine-executable instructions are executed by a machine (e.g., one or more processors), one or more methods described herein are performed. In at least one example, machine-readable storage media is a tangible non-transitory machine-readable media. In at least one example, machine-readable storage media comprises one of volatile or non-volatile memory, or a combination of them.

The following are additional examples provided in view of the above-described implementations. Here, one or more features of example, in isolation or in combination, can be combined with one or more features of one or more other examples to form further examples also falling within the scope of the disclosure. As such, one implementation can be combined with one or more other implementation without changing scope of disclosure.

Example 1 is an integrated circuit, comprising a first power stage coupled to an input power supply rail, wherein the first power stage is configured to drive a first current to an output power supply rail; a second power stage coupled to the input power supply rail, wherein the first power stage is configured to drive a second current to the output power supply rail; and a control circuitry coupled to the first power stage and the second power stage, wherein the control circuitry is configured to generate a first pulse width modulated signal for the first power stage, wherein the control circuitry is configured to generate a second pulse width modulated signal for the second power stage, wherein the control circuitry is configured to align rise and fall times of the first pulse width modulated signal and the second pulse width modulated signal based on an undershoot condition being detected on the output power supply rail.

Example 2 is an integrated circuit of any example herein, particularly example 1, wherein the control circuitry is configured to generate the first pulse width modulated signal and the second pulse width modulated signal in a round robin manner after the undershoot condition lapses.

Example 3 is an integrated circuit of any example herein, particularly example 1, wherein the control circuitry is configured to generate a plurality of pulse width modulated signals including the first pulse width modulated signal and the second pulse width modulated signal, wherein the control circuitry is configured to align rise and fall times of a first group of plurality of pulse width modulated signals, wherein the control circuitry is configured to align rise and fall times of a second group of plurality of pulse width modulated signals based on the undershoot condition being detected, and wherein the first group of plurality of pulse width modulated signals is separated in time from the second group of plurality of pulse width modulated signals.

Example 4 is an integrated circuit of any example herein, particularly example 3, wherein a number of pulse width modulated signals in the first group of plurality of pulse width modulated signals is programmable.

Example 5 is an integrated circuit of any example herein, particularly example 3, wherein a number of pulse width modulated signals in the first group of plurality of pulse width modulated signals is programmable.

Example 6 is an integrated circuit of any example herein, particularly example 1, wherein the first power stage is coupled to a first inductor, wherein the second power stage is coupled to a second inductor, wherein the first inductor and the second inductor are coupled to a capacitor, wherein the capacitor is coupled to one or more loads.

Example 7 is a system comprising: a first inductor; a second inductor; a capacitor coupled to the first inductor and the second inductor; a processor circuitry coupled to the first inductor, the second inductor, and the capacitor; and an integrated circuit coupled to the first inductor and the second inductor, wherein the integrated circuit comprises: a first power stage coupled to an input power supply rail, wherein the first power stage is configured to drive a first current to an output power supply rail; a second power stage coupled to the input power supply rail, wherein the first power stage is configured to drive a second current to the output power supply rail; and a control circuitry coupled to the first power stage and the second power stage, wherein the control circuitry is configured to generate a first pulse width modulated signal for the first power stage, wherein the control circuitry is configured to generate a second pulse width modulated signal for the second power stage, wherein the control circuitry is configured to align rise and fall times of the first pulse width modulated signal and the second pulse width modulated signal based on an undershoot condition being detected on the output power supply rail.

Example 8 is a system of any example herein, particularly example 7, wherein the control circuitry is configured to generate the first pulse width modulated signal and the second pulse width modulated signal in a round robin manner after the undershoot condition substantially lapses.

Example 9 is a system of any example herein, particularly example 7, wherein the first power stage is configured to drive a first current to the output power supply rail in accordance with the first pulse width modulated signal.

Example 10 is a system of any example herein, particularly example 7, wherein the second power stage is configured to drive a second current to the output power supply rail in accordance with the second pulse width modulated signal.

Example 11 is a system of any example herein, particularly example 7, wherein the control circuitry to generate a plurality of pulse width modulated signals including the first pulse width modulated signal and the second pulse width modulated signal, wherein the control circuitry to align rise and fall times of a first group of plurality of pulse width modulated signals, wherein the control circuitry to align rise and fall times of a second group of plurality of pulse width modulated signals based on the undershoot condition being detected, and wherein the first group of plurality of pulse width modulated signals is separated in time from the second group of plurality of pulse width modulated signals.

Example 12 is a system of any example herein, particularly example 11, wherein a number of pulse width modulated signals in the first group of plurality of pulse width modulated signals is programmable.

Example 13 is a system of any example herein, particularly example 11, wherein a number of pulse width modulated signals in the first group of plurality of pulse width modulated signals is programmable.

Example 14 is a system of any example herein, particularly example 7, wherein the processor circuitry comprises one or more processor cores.

Example 15 is a system of any example herein, particularly example 7, wherein the integrated circuit includes a sensor circuitry to detect the undershoot condition.

Example 16 is a system of any example herein, particularly example 7, further comprises a memory coupled to the processor circuitry.

Example 17 is one or more non-transitory machine-readable storage media having machine-readable instructions stored thereon that when executed, cause one or more machines to perform a method comprising: driving a first current to an output power supply rail; driving a second current to the output power supply rail; generating a first pulse width modulated signal to produce the first current; generating a second pulse width modulated signal to produce the second current; detecting an undershoot condition on the output power supply rail; and aligning rise and fall times of the first pulse width modulated signal and the second pulse width modulated signal based on the undershoot condition being detected on the output power supply rail.

Example 18 is one or more non-transitory machine-readable storage media of any example herein, particularly example 17, wherein generating the first pulse width modulated signal and the second pulse width modulated signal comprising generating the first pulse width modulated signal and the second pulse width modulated signal in a round robin manner after the undershoot condition lapses.

Example 19 is one or more non-transitory machine-readable storage media of any example herein, particularly example 17, having further machine-readable instructions stored thereon that when executed, cause the one or more machines to perform a further method comprising: generating a plurality of pulse width modulated signals including the first pulse width modulated signal and the second pulse width modulated signal; aligning rise and fall times of a first group of plurality of pulse width modulated signals; aligning rise and fall times of a second group of plurality of pulse width modulated signals based on the undershoot condition being detected; and separating in time the first group of plurality of pulse width modulated signals from the second group of plurality of pulse width modulated signals.

Example 20 is one or more non-transitory machine-readable storage media of any example herein, particularly example 19, wherein a number of pulse width modulated signals in the first group of plurality of pulse width modulated signals are programmable, and wherein a number of pulse width modulated signals in the second group of plurality of pulse width modulated signals are programmable.

Example 21 is an integrated circuit comprising: one or more circuitries to align rise and fall times of a first pulse width modulated signal and a second pulse width modulated signal based on an undershoot condition being detected on an output power supply rail.

Example 22 is an integrated circuit according to any example herein, particularly example 21, wherein the one or more circuitries are configured to generate the first pulse width modulated signal and the second pulse width modulated signal in a round robin manner after the undershoot condition substantially lapses.

Example 23 is an integrated circuit according to any example herein, particularly example 21, further comprising: a first power stage coupled to an input power supply rail, wherein the first power stage is configured to drive a first current to the output power supply rail in accordance with the first pulse width modulated signal.

Example 24 is an integrated circuit according to any example herein, particularly example 21 further comprising: a second power stage coupled to the input power supply rail, wherein the second power stage is configured to drive a second current to the output power supply rail in accordance with the second pulse width modulated signal.

Example 25 is a method comprising aligning rise and fall times of a first pulse width modulated signal and a second pulse width modulated signal based on an undershoot condition being detected on an output power supply rail.

Example 26 is a method according to any example herein, particularly example 25, further comprising generating the first pulse width modulated signal and the second pulse width modulated signal in a round robin manner after the undershoot condition substantially lapses.

Example 27 is a method according to any example herein, particularly example 25, further comprising driving a first current to the output power supply rail in accordance with the first pulse width modulated signal.

Example 28 is a method according to any example herein, particularly example 25, further comprising driving a second current to the output power supply rail in accordance with the second pulse width modulated signal.

Example 1a is an integrated circuit comprising: a first power stage coupled to an input power supply rail, wherein the first power stage is configured to drive a first current to an output power supply rail; a second power stage coupled to the input power supply rail, wherein the first power stage is configured to drive a second current to the output power supply rail; and a control circuitry coupled to the first power stage and the second power stage, wherein the control circuitry is configured to generate a first pulse width modulated signal for the first power stage, wherein the control circuitry is configured to generate a second pulse width modulated signal for the second power stage, wherein the control circuitry is configured to extend a first pulse width of the first pulse width modulated signal based on an undershoot condition being detected on the output power supply rail, wherein the control circuitry is configured to extend a second pulse width of the second pulse width modulated signal based on the undershoot condition being detected on the output power supply rail.

Example 2a is an integrated circuit according to any example herein, particularly example 1a, wherein the control circuitry is configured to reduce the first pulse width over one or more successive cycles after it is detected that the undershoot condition has ended.

Example 3a is an integrated circuit according to any example herein, particularly example 1a, wherein the control circuitry is configured to reduce the first pulse width and the second pulse width by a first programmable delay value.

Example 4a is an integrated circuit according to any example herein, particularly example 3a, which further comprises a first register to store the first programmable delay value.

Example 5a is an integrated circuit according to any example herein, particularly example 1a, wherein the control circuitry is configured to extend the first pulse width and the second pulse width by a second programmable delay value.

Example 6a is an integrated circuit according to any example herein, particularly example 5a, which further comprises a second register to store the second programmable delay value.

Example 7a is an integrated circuit according to any example herein, particularly example 1a, wherein the first power stage is coupled to a first inductor, wherein the second power stage is coupled to a second inductor, wherein the first inductor and the second inductor are coupled to a capacitor, and wherein the capacitor is coupled to one or more loads.

Example 8a is a system comprising: a first inductor; a second inductor; a capacitor coupled to the first inductor and the second inductor; a processor circuitry coupled to the first inductor, the second inductor, and the capacitor; and an integrated circuit coupled to the first inductor and the second inductor, wherein the integrated circuit comprises: a first power stage coupled to an input power supply rail, wherein the first power stage is configured to drive a first current to an output power supply rail; a second power stage coupled to the input power supply rail, wherein the first power stage is configured to drive a second current to the output power supply rail; and a control circuitry coupled to the first power stage and the second power stage, wherein the control circuitry is configured to generate a first pulse width modulated signal for the first power stage, wherein the control circuitry is configured to generate a second pulse width modulated signal for the second power stage, wherein the control circuitry is configured to extend a first pulse width of the first pulse width modulated signal based on an undershoot condition being detected on the output power supply rail, and wherein the control circuitry is configured to extend a second pulse width of the second pulse width modulated signal based on the undershoot condition being detected on the output power supply rail.

Example 9a is a system according to any example herein, particularly example 8a, wherein the control circuitry is configured to reduce the first pulse width over one or more successive cycles after it is detected that the undershoot condition has ended.

Example 10a is an integrated circuit according to any example herein, particularly example 8a, wherein the control circuitry is configured to reduce the first pulse width and the second pulse width by a first programmable delay value.

Example 11a is a system according to any example herein, particularly example 10a, wherein the integrated circuit comprises a first register to store the first programmable delay value.

Example 12a is a system according to any example herein, particularly example 8a, wherein the control circuitry is configured to extend the first pulse width and the second pulse width by a second programmable delay value.

Example 13a is a system according to any example herein, particularly example 12a, wherein the integrated circuit comprises a second register to store the second programmable delay value.

Example 14a is a system according to any example herein, particularly example 8a, wherein the first power stage is coupled to a first inductor, wherein the second power stage is coupled to a second inductor, wherein the first inductor and the second inductor are coupled to a capacitor, wherein the capacitor is coupled to one or more loads.

Example 15a is a system according to any example herein, particularly example 8a, wherein the processor circuitry comprises one or more processor cores.

Example 16a is a system according to any example herein, particularly example 8a, wherein the integrated circuit includes a sensor circuitry to detect the undershoot condition.

Example 17a is a system according to any example herein, particularly example 8a, which further comprises a memory coupled to the processor circuitry.

Example 18a is one or more non-transitory machine-readable storage media having machine-readable instructions stored thereon that when executed, cause one or more machines to perform a method comprising: driving a first current to an output power supply rail; driving a second current to the output power supply rail; generating a first pulse width modulated signal to produce the first current; generating a second pulse width modulated signal to produce the second current; detecting an undershoot condition on the output power supply rail; extending a first pulse width of the first pulse width modulated signal based on the undershoot condition being detected on the output power supply rail; and extending a second pulse width of the second pulse width modulated signal based on the undershoot condition being detected on the output power supply rail.

Example 19a is one or more non-transitory machine-readable storage media of any example herein, particularly example 18a, having further machine-readable instructions stored thereon that when executed, cause the one or more machines to perform a further method comprising reducing the first pulse width over one or more successive cycles after it is detected that the undershoot condition has ended.

Example 20a is one or more non-transitory machine-readable storage media of any example herein, particularly example 19a, having further machine-readable instructions stored thereon that when executed, cause the one or more machines to perform a further method comprising: reducing the first pulse width and the second pulse width by a first programmable delay value; and storing the first programmable delay value.

Example 21a is one or more non-transitory machine-readable storage media of any example herein, particularly example 18a, having further machine-readable instructions stored thereon that when executed, cause the one or more machines to perform a further method comprising: extending the first pulse width and the second pulse width by a second programmable delay value; and storing the second programmable delay value.

Example 1b is an integrated circuit comprising: a first power stage coupled to an input power supply rail, wherein the first power stage is configured to drive a first current to an output power supply rail; a second power stage coupled to the input power supply rail, wherein the first power stage is configured to drive a second current to the output power supply rail; and a control circuitry coupled to the first power stage and the second power stage, wherein the control circuitry is configured to generate a first pulse width modulated signal for the first power stage, wherein the control circuitry is configured to generate a second pulse width modulated signal for the second power stage, wherein the control circuitry is configured to increase a number of pulses of the first pulse width modulated signal based on an undershoot condition being detected on the output power supply rail, wherein the control circuitry is configured to increase a number of pulses of the second pulse width modulated signal based on the undershoot condition being detected on the output power supply rail.

Example 2b is an integrated circuit according to any example herein, particularly example 1b, wherein the control circuitry is configured to reduce the number of pulses of the first pulse width modulated signal over one or more successive cycles after it is detected that the undershoot condition has substantially ended.

Example 3b is an integrated circuit according to any example herein, particularly example 1b wherein the control circuitry is configured to increase the number of pulses of the first pulse width modulated signal by control of an output of a pulse modulation comparator.

Example 4b is an integrated circuit according to any example herein, particularly example 1b, wherein a maximum number of pulses of the first pulse width modulated signal in the undershoot condition is a programmable number.

Example 5b is an integrated circuit according to any example herein, particularly example 1b, wherein the first power stage is coupled to a first inductor, wherein the second power stage is coupled to a second inductor, wherein the first inductor and the second inductor are coupled to a capacitor, wherein the capacitor is coupled to one or more loads.

Example 6b is an integrated circuit comprising: a first power stage coupled to an input power supply rail, wherein the first power stage is configured to drive a first current to an output power supply rail; a second power stage coupled to the input power supply rail, wherein the first power stage is configured to drive a second current to the output power supply rail; and a control circuitry coupled to the first power stage and the second power stage, wherein the control circuitry is configured to generate a first pulse width modulated signal for the first power stage, wherein the control circuitry is configured to generate a second pulse width modulated signal for the second power stage, wherein the control circuitry includes a comparator which compares an average current error or average voltage error with a reference, wherein the control circuitry is configured to adjust a duration for the comparator to be active based on detection of an undershoot condition on the output power supply rail and based on lapse of the undershoot condition.

Example 7b is an integrated circuit according to any example herein, particularly example 6b, wherein the control circuitry is configured to increase the duration the comparator is active in the undershoot condition.

Example 8b is an integrated circuit according to any example herein, particularly example 6b, wherein the control circuitry is configured to decrease the duration the comparator is active after the undershoot condition lapses.

Example 9b is an integrated circuit according to any example herein, particularly example 6b, further comprising a register to store a value indicative of the duration.

Example 10b is an integrated circuit according to any example herein, particularly example 9b, wherein the value is a programmable value.

Example 11b is an integrated circuit according to any example herein, particularly example 6b, wherein the first power stage is coupled to a first inductor, wherein the second power stage is coupled to a second inductor, wherein the first inductor and the second inductor are coupled to a capacitor, wherein the capacitor is coupled to one or more loads.

Example 12b is a system comprising: a first inductor; a second inductor; a capacitor coupled to the first inductor and the second inductor; a processor circuitry coupled to the first inductor, the second inductor, and the capacitor; and an integrated circuit coupled to the first inductor and the second inductor, wherein the integrated circuit comprises: a first power stage coupled to an input power supply rail, wherein the first power stage is configured to drive a first current to an output power supply rail; a second power stage coupled to the input power supply rail, wherein the first power stage is configured to drive a second current to the output power supply rail; and one or more circuitries coupled to the first power stage and the second power stage, wherein the one or more circuitries are configured to generate a first pulse width modulated signal for the first power stage, wherein the one or more circuitries are configured to generate a second pulse width modulated signal for the second power stage, wherein the one or more circuitries are configured to increase a number of pulses of the first pulse width modulated signal based on an undershoot condition being detected on the output power supply rail, wherein the one or more circuitries are configured to increase a number of pulses of the second pulse width modulated signal based on the undershoot condition being detected on the output power supply rail.

Example 13b is a system according to any example herein, particularly example 12b, wherein the one or more circuitries are configured to reduce the number of pulses of the first pulse width modulated signal over one or more successive cycles after it is detected that the undershoot condition has substantially ended.

Example 14b is a system according to any example herein, particularly example 12b, wherein the one or more circuitries are configured to increase the number of pulses of the first pulse width modulated signal by control of an output of a pulse modulation comparator.

Example 15b is a system according to any example herein, particularly example 12b, wherein a maximum number of pulses of the first pulse width modulated signal in the undershoot condition is a programmable number.

Example 16b is a system according to any example herein, particularly example 12b, wherein the first power stage is coupled to a first inductor, wherein the second power stage is coupled to a second inductor, wherein the first inductor and the second inductor are coupled to a capacitor, wherein the capacitor is coupled to one or more loads.

Example 17b is a non-transitory machine-readable storage media having machine-readable instructions stored thereon that when executed, cause one or more machines to perform a method comprising: driving a first current to an output power supply rail; driving a second current to the output power supply rail; generating a first pulse width modulated signal to produce the first current; generating a second pulse width modulated signal to produce the second current; detecting an undershoot condition on the output power supply rail; comparing, by a comparator, an average current error or average voltage error with a reference; and adjusting a duration for the comparator to be active based on detection of the undershoot condition on the output power supply rail and based on lapse of the undershoot condition.

Example 18b is one or more non-transitory machine-readable storage media of any example herein, particularly example 17b, having further machine-readable instructions stored thereon that when executed, cause the one or more machines to perform a further method comprising increasing the duration the comparator is active in the undershoot condition.

Example 19b is one or more non-transitory machine-readable storage media of any example herein, particularly example 17b, having further machine-readable instructions stored thereon that when executed, cause the one or more machines to perform a further method comprising: decreasing the duration the comparator is active after the undershoot condition lapses.

Example 20b is one or more non-transitory machine-readable storage media of any example herein, particularly example 17b, having further machine-readable instructions stored thereon that, when executed, cause the one or more machines to perform a further method comprising storing a value indicative of the duration.

Besides what is described herein, various modifications can be made to disclose implementations and implementations thereof without departing from their scope. Therefore, illustrations of implementations herein should be construed as examples, and not restrictive to scope of present disclosure.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are

1. An integrated circuit comprising:
a first power stage coupled to an input power supply rail, wherein the first power stage is configured to drive a first current to an output power supply rail;
a second power stage coupled to the input power supply rail, wherein the first power stage is configured to drive a second current to the output power supply rail; and
a control circuitry coupled to the first power stage and the second power stage, wherein the control circuitry is configured to generate a first pulse width modulated signal for the first power stage, wherein the control circuitry is configured to generate a second pulse width modulated signal for the second power stage, wherein the control circuitry is configured to align rise and fall times of the first pulse width modulated signal and the second pulse width modulated signal based on an undershoot condition being detected on the output power supply rail.

2. The integrated circuit of claim 1, wherein the control circuitry is configured to generate the first pulse width modulated signal and the second pulse width modulated signal in a round robin manner after the undershoot condition lapses.

3. The integrated circuit of claim 1, wherein the control circuitry is configured to generate a plurality of pulse width modulated signals including the first pulse width modulated signal and the second pulse width modulated signal, wherein the control circuitry is configured to align rise and fall times of a first group of plurality of pulse width modulated signals, wherein the control circuitry is configured to align rise and fall times of a second group of plurality of pulse width modulated signals based on the undershoot condition being detected, and wherein the first group of plurality of pulse width modulated signals is separated in time from the second group of plurality of pulse width modulated signals.

4. The integrated circuit of claim 3, wherein a number of pulse width modulated signals in the first group of plurality of pulse width modulated signals is programmable.

5. The integrated circuit of claim 3, wherein a number of pulse width modulated signals in the first group of plurality of pulse width modulated signals is programmable.

6. The integrated circuit of claim 1, wherein the first power stage is coupled to a first inductor, wherein the second power stage is coupled to a second inductor, wherein the first inductor and the second inductor are coupled to a capacitor, wherein the capacitor is coupled to one or more loads.

7. A system comprising:
a first inductor;
a second inductor;
a capacitor coupled to the first inductor and the second inductor;
a processor circuitry coupled to the first inductor, the second inductor, and the capacitor; and
an integrated circuit coupled to the first inductor and the second inductor, wherein the integrated circuit comprises:
a first power stage coupled to an input power supply rail, wherein the first power stage is configured to drive a first current to an output power supply rail;
a second power stage coupled to the input power supply rail, wherein the first power stage is configured to drive a second current to the output power supply rail; and
a control circuitry coupled to the first power stage and the second power stage, wherein the control circuitry is configured to generate a first pulse width modulated signal for the first power stage, wherein the control circuitry is configured to generate a second pulse width modulated signal for the second power stage, wherein the control circuitry is configured to align rise and fall times of the first pulse width modulated signal and the second pulse width modulated signal based on an undershoot condition being detected on the output power supply rail.

8. The system of claim 7, wherein the control circuitry is configured to generate the first pulse width modulated signal and the second pulse width modulated signal in a round robin manner after the undershoot condition substantially lapses.

9. The system of claim 7, wherein the first power stage is configured to drive a first current to the output power supply rail in accordance with the first pulse width modulated signal.

10. The system of claim 7, wherein the second power stage is configured to drive a second current to the output power supply rail in accordance with the second pulse width modulated signal.

11. The system of claim 7, wherein the control circuitry is configured to generate a plurality of pulse width modulated signals including the first pulse width modulated signal and the second pulse width modulated signal, wherein the control circuitry is configured to align rise and fall times of a first group of plurality of pulse width modulated signals, wherein the control circuitry is configured to align rise and fall times of a second group of plurality of pulse width modulated signals based on the undershoot condition being detected, and wherein the first group of plurality of pulse width modulated signals is separated in time from the second group of plurality of pulse width modulated signals.

12. The system of claim 11, wherein a number of pulse width modulated signals in the first group of plurality of pulse width modulated signals is programmable.

13. The system of claim 11, wherein a number of pulse width modulated signals in the first group of plurality of pulse width modulated signals is programmable.

14. The system of claim 7, wherein the processor circuitry comprises one or more processor cores.

15. The system of claim 7, wherein the integrated circuit includes a sensor circuitry to detect the undershoot condition.

16. The system of claim 7 further comprises a memory coupled to the processor circuitry.

17. One or more non-transitory machine-readable storage media having machine-readable instructions stored thereon that when executed, cause one or more machines to perform a method comprising:
driving a first current to an output power supply rail;
driving a second current to the output power supply rail;
generating a first pulse width modulated signal to produce the first current;
generating a second pulse width modulated signal to produce the second current;
detecting an undershoot condition on the output power supply rail; and
aligning rise and fall times of the first pulse width modulated signal and the second pulse width modulated signal based on the undershoot condition being detected on the output power supply rail.

18. The one or more non-transitory machine-readable storage media of claim 17, wherein generating the first pulse width modulated signal and the second pulse width modulated signal comprises generating the first pulse width modulated signal and the second pulse width modulated signal in a round robin manner after the undershoot condition lapses.

19. The one or more non-transitory machine-readable storage media of claim 17 having further machine-readable instructions stored thereon that when executed, cause the one or more machines to perform a further method comprising:
generating a plurality of pulse width modulated signals including the first pulse width modulated signal and the second pulse width modulated signal;
aligning rise and fall times of a first group of plurality of pulse width modulated signals;
aligning rise and fall times of a second group of plurality of pulse width modulated signals based on the undershoot condition being detected; and
separating in time the first group of plurality of pulse width modulated signals from the second group of plurality of pulse width modulated signals.

20. The one or more non-transitory machine-readable storage media of claim 19, wherein a number of pulse width modulated signals in the first group of plurality of pulse width modulated signals is programmable, and wherein a number of pulse width modulated signals in the second group of plurality of pulse width modulated signals is programmable.
